(19) United States
(12) Patent Application Publication
(10) Pub. No.: US 2025/0037129 A1
(43) Pub. Date: Jan. 30, 2025

(54) Method and System for Verifying Transactions

(71) Applicant: CityCheers Media, Dallas, TX (US)

(72) Inventors: Igor Jonatan Schmidt, Dallas, TX (US); Winston Jaeb, Dallas, TX (US)

(21) Appl. No.: 18/784,104

(22) Filed: Jul. 25, 2024

Related U.S. Application Data
(60) Provisional application No. 63/529,645, filed on Jul. 28, 2023.

(51) Int. Cl. G06Q 20/40; G06Q 20/20

(52) U.S. Cl. CPC G06Q 20/40145; G06Q 20/209

(57) ABSTRACT

A method of creating an electronic transaction record between a customer and a merchant is presented. The method entails generating a digital payment certificate that includes the customer's biometric authentication token that is associated with a time of payment instruction from the customer to use a payment method, and generating a digital receipt signed with the digital payment certificate after executing the payment instruction using the payment method. A database of customer's biometric data and associated payment methods is maintained. If a customer's biometric authentication token does not match the stored biometric data for the payment method in the payment instruction, the payment is rejected. The method and system not only prevents fraud, it also provides a validated record of payment.

### CROSS-REFERENCE TO RELATED APPLICATION

This application claims the benefit of U.S. Provisional Application No. 63/529,645 filed on Jul. 28, 2023, the content of which is incorporated herein by reference.

### BACKGROUND

Present disclosure relates to a system for authenticating and verifying electronic transactions.

Credit card users make a mind-boggling number of daily transactions every year, in the United States and countries across the globe. Credit card payments in 2018 totaled $44.7 billion in the U.S. alone, according to the 2019 Federal Reserve Payments Study. The speed at which these transactions process is awe-inspiring. Credit cards can settle 5,000 transactions per second.

There were 39.6 billion combined purchase transactions in the U.S. in 2019. This figure includes 31.2 billion purchase transactions from the top 50 issuers of Visa and Mastercard credit cards in the U.S., plus another 5.66 billion from American Express and 2.72 billion from Discover. If you divide that figure by 365, the results show that more than 108.6 million credit card transactions occur in the U.S. everyday.

Unsurprisingly, the rise in credit card usage is accompanied by a rise in credit card fraud. A 2019 American Express Digital Payments Survey findings are as follows:
69% of U.S. merchants said that a significant amount of company time and expenses are dedicated to dealing with payment fraud.
77% of U.S. merchant respondents said that their companies experienced some type of fraud over the course of being in business.
U.S. merchants found that 27% of their annual online sales are fraudulent transactions, a significant increase from 18% in 2018.
42% of consumers said they experienced a fraudulent attempt to use their credit card or other payment information.
59% of consumers surveyed said they are worried about having their payment account or credit card information compromised when making an online purchase.

Merchants responding to the American Express survey expressed interest in investing in payment data security. Thirty-three percent say they are increasing their budget for such data security systems. Credit card companies are also concerned about losses due to transaction fraud. A 2018 Nilson Report found that $27.85 billion was lost to fraudulent activity, with $9.47 billion of those losses occurring in the U.S. alone.

A method and system to bolster the security on credit card transactions is needed.

### SUMMARY

A method of creating a validated electronic record between a customer and a merchant is disclosed. The method entails generating a digital payment certificate that includes the customer's biometric authentication token that is associated with a time of payment instruction from the customer, wherein the payment instruction includes a payment method, and generating a digital receipt signed with the digital payment certificate after executing the payment instruction using the payment method.

The method may also entail generating a digital log-in certificate that includes at least one of a customer's biometric authentication token and a location token at a check-in time.

The method may entail maintaining a database of customer information including biometric data for a plurality of customers and at least one method of payment associated with each one of the biometric data. The method may compare the customer's biometric authentication token against the biometric data in the customer database before applying a charge to the payment method.

One or more non-transitory computer-readable media collectively storing instructions that, when executed, cause one or more computers to collectively perform the above-described method of creating a validated electronic record is also presented.

If a charge dispute arises, the digital payment certificate may be used to determine the validity of the charge.

### BRIEF DESCRIPTION OF THE FIGURES

For a better understanding of the invention, reference should be made to the following detailed description taken in conjunction with the accompanying drawings, in which:

FIG. 1 depicts a computer-based system for implementing an embodiment of the disclosure;

FIG. 2 depicts a server in the transaction support system that may be used for implementing an embodiment of the disclosure;

FIG. 3 depicts the verified electronic transaction process in accordance with an embodiment of the disclosure;

FIG. 4 depicts the check-in process of the verified electronic transaction process in accordance with an embodiment of the disclosure;

FIG. 5 depicts the payment process of the verified electronic transaction process in accordance with an embodiment of the disclosure;

FIG. 6 depicts Visit Logs created by the transaction support server, in accordance with an embodiment of the disclosure;

FIG. 7 depicts a dispute resolution process using the Visit Logs, in accordance with an embodiment of the disclosure;

FIG. 8 depicts a dispute resolution process using the Visit Logs, in accordance with another embodiment of the disclosure;

FIG. 9 depicts the verified transaction process carried out at a fueling station, in accordance with an embodiment of the disclosure; and

FIG. 10 depicts the verified transaction process carried out at a retail store, in accordance with an embodiment of the disclosure.

FIG. 11 depicts a merchant system in communication with a web-based credit card processing engine that may work with the transaction support system of the disclosure.

Like reference numerals refer to corresponding parts throughout the drawings. The Figures are not necessarily to scale.

### DETAILED DESCRIPTION

The disclosure pertains to a method and system that allow customers and merchants to engage in electronic transactions with verifications built in, and to maintain records of the verifications that may be used in case of a charge dispute. Biometric authentication and location authentication are used to create an almost unchallengeable record of the customer's purchases.

A chargeback is a charge that is returned to a payment card after a customer successfully disputes an item on their account statement or transactions report. A chargeback may occur on debit cards (and the underlying bank account) or on credit cards. Chargebacks can be granted to a cardholder for a variety of reasons. Merchants typically incur a fee from the card issuer when a chargeback occurs. Sometimes, there is a fee from the card issuer for initiating a chargeback. The system and method presented herein should reduce the number of chargebacks by maintaining irrefutable records of authenticated payments.

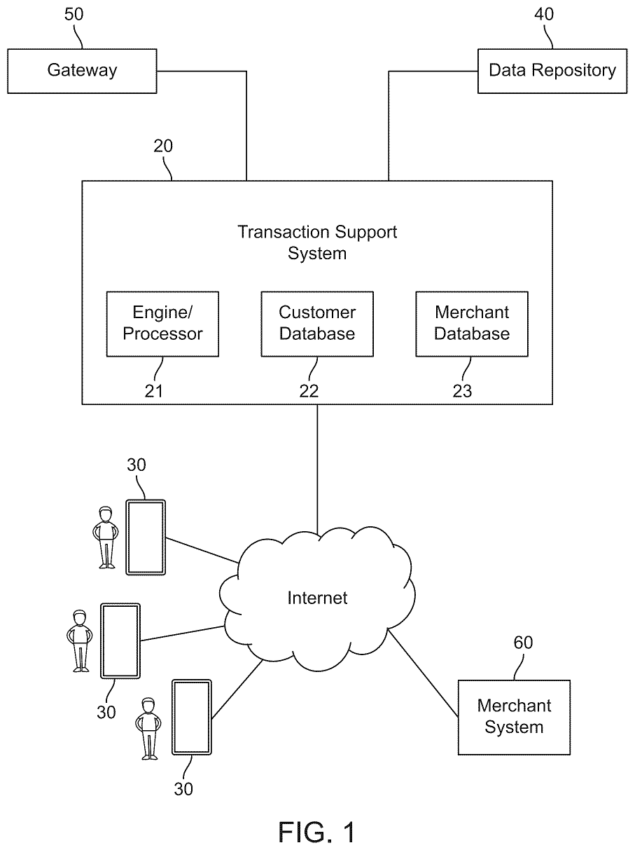

FIG. 1 illustrates an electronic transaction system 10 for implementing an embodiment of the disclosure. Generally, the electronic transaction system 10 includes a transaction support server 20 communicating with a merchant system 60 and customer devices 30 via a communication network (e.g., the Internet). The transaction support server 20 communicates with a Data Repository 40, and is able to store data or retrieve data from the Data Repository 40. Although FIG. 1 shows three customer devices 30 and one merchant system 60, this is done for simplicity of illustration and there is no limit to the number of customer devices 30 and merchant systems 60 that may be included in the transaction system 10. The customer device 30 may be any computing device with network connection capability, including but not limited to smart phones, tablets, mobile phones, laptops, etc.

The merchant system 60 may include a merchant interface program implemented on a computing device that determines the charges a customer incurred and transmits the charge amount, e.g. in the form of a bill or invoice, to the customer device 30. The merchant system 60 may have an interface that allows it to receive data (e.g., from a merchant employee or a scanner) that can be used to calculate the charge amount. The merchant interface program may be a website, a mobile application, or a native application. In some embodiments, the merchant system 60 may have a POS 62 with a plug-in application that connects the POS to the transaction support system 20, in the manner described in U.S. Patent Application Publication No. 2021/0216986.

The gateway 50 is a known hosted software product that provides integration between the websites and other elements of an electronic payment processing network. These elements include credit card networks and bank servers. The other elements and their interactions with gateway 50 are known.

The transaction support system 20 may include an engine or processor 21, a customer database 22, and a merchant database 23. The customer database 22 stores information about all the customers (associated with customer devices 30) who opened an account with the transaction support system 20. A customer's creation of an account entails providing information such as username, phone number, email address, and residential address, and setting up payment information (credit/debit card, digital wallet, etc.). The customer account is set up with multiple layers of verification requiring a valid phone number of the customer (the owner of the credit card). In some embodiments, the initial biometric verification during sign up process may retrieve data from Apple or Google biometric enrollment. All the customer data is associated with one or more methods of payment, such as credit card numbers or bank accounts. Hence, if a scammer or thief tries to create an account with a stolen credit card, he will have a hard time due to failed biometrics match. Other layers of verification may require the phone number, the address or zip code, and other personal information to match for account setup. The customer's biometric data (based on any known scans of iris, fingerprint, face, etc.) may be performed during the account set-up process. Each registered customer's data, including biometric data, is stored in the customer database 22 and associated with a set of payment methods.

The merchant database 23 contains information of all the merchants who are registered with the transaction support system 20. To become included in the merchant database 23, a merchant opens an account with the transaction support system 20 by providing basic information such as merchant name, address(es), logo, etc. and open an account with the gateway 50. Once gateway approval is granted, the gateway 50 sends merchant-specific gateway credentials to transaction support system 20, where they may be stored in the merchant database 23.

When a customer checks in, as will be described below, the check-in is specific to a merchant. Upon receiving a check-in notice, the merchant system finds the merchant on the merchant database 23 to create a ticket with the specific customer and the specific merchant. If the merchant is not in the merchant database 23, a message such as “Merchant not found in system” will be transmitted to the customer device 30 that attempted the check-in.

The transaction support system 20 may be a single physical server or multiple servers that are not necessarily in the same geographic location, and may be implemented as one or more virtual servers.

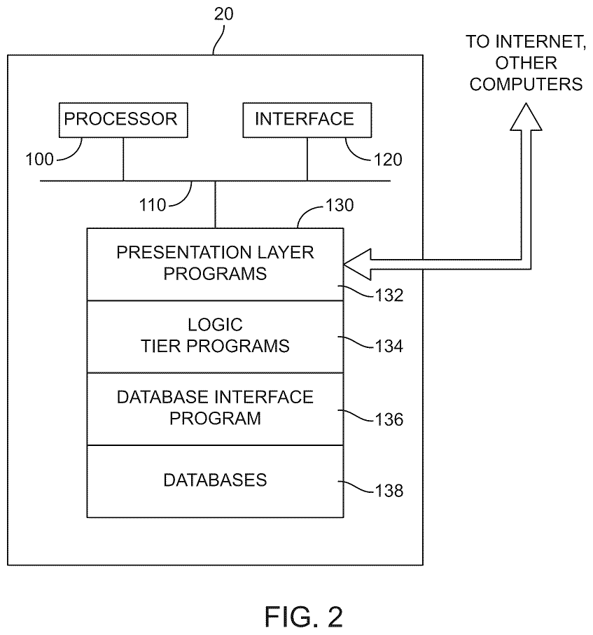

FIG. 2 depicts details of an embodiment of a server in the transaction support system 20. As shown, the transaction support system 20 includes a processor 100, a bus 110, interface 120, and a memory 130. The processor 100, interface 120, and memory 130 are in communication across bus 110. The processor 100 executes instructions contained in the programs of memory 130, while the interface 120 allows communication with the other computational devices of FIG. 1 via the Internet or other electronic communication medium. The processor 100, interface 120, and programs of the memory 130 that carry out the processes disclosed herein may collectively make up the engine/processor 21.

The memory 130 stores a number of programs, including presentation layer programs 132, logic tier programs 134, database interface programs 136, and databases 138. The databases 138 may include any of the databases used to organize and store information, including the customer database 22 and merchant database 23. The database interface programs 136 may include those programs configured to act as an interface for the databases 138 to the logic tier 134, as is known. The logic tier programs 134 are database access layer programs that access the database interface programs 136 as well as other remote programs (such as financial transaction, authentication, etc. programs) to retrieve desired information stored in the databases 138 or store information as appropriate. The logic tier programs 134 transfer information between end user application programs and databases 138, to allow for the transfer of information between the databases 138 and end users. The construction of such logic tier programs 134 is known. The presentation layer programs 132 are application programs providing an interface to end users.

The web-based design of the transaction support system 20, customer device 30, and merchant device 40 make the system platform independent, allowing a common interface readily available on a wide variety of devices ranging from notebooks and computers to tablets and mobile devices. This platform-independence makes the system versatile and easier to adapt and deploy regardless of the specific POS systems involved.

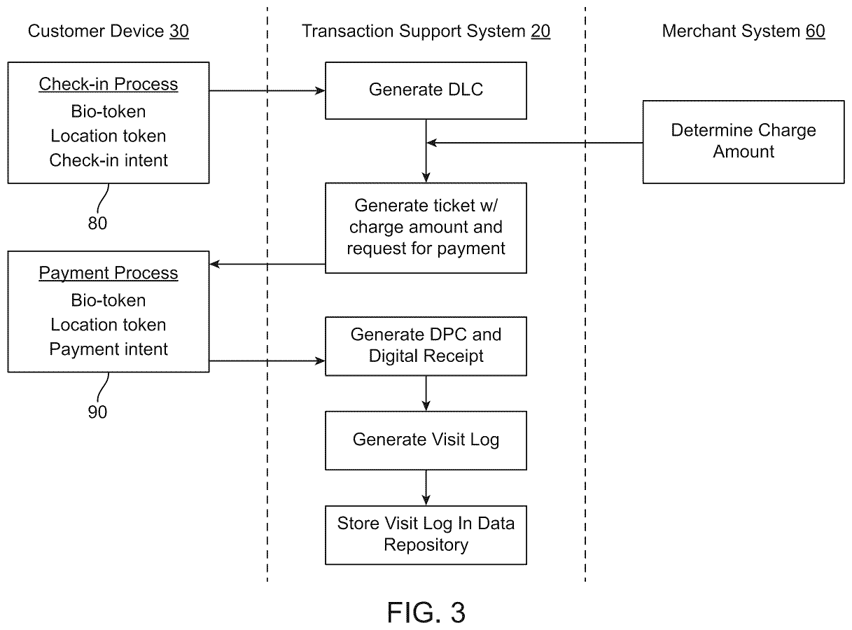

FIG. 3 depicts the electronic transaction process that happens with the transaction system 10. A customer device 30 (which may be carried by a customer) checks in with the transaction support system 20, usually but not always from a merchant venue. The merchant venue is where the customer intends to make a transaction, and may be a restaurant, a hotel, a gas station, or a retail store, among other possibilities. During the check-in process 80, the customer device 30 creates a biometric user authentication token and a location token. The biometric user authentication token authenticates the user by using any suitable known method of bio authentication such as iris scan, a fingerprint, a retina scan, or some other physical characteristic recognition method including but not limited to facial recognition. The location token makes a clear record of the location where the user was at the time he checked into the application, and may be implemented using any suitable known geolocation method. The customer device transmits the bio authentication and location tokens to the transaction support server 20. The transaction support server 20 combines the two tokens to generate a Digital Login Certificate (DLC), which contains some or all of the following information:
customer name
biometric verification token (AT)
merchant name
verified geo location (LT)
date and time stamp
check-in intent (e.g., activation of a “check-in” button)
   The DLC proves authenticity of the end user and his location at the time of check-in.

During the check-in process, the transaction support server 20 may compare the biometrics authentication token with the biometrics data that is stored and associated with the selected method of payment. If there is a biometrics mismatch or any other data mismatch, the check-in may get flagged or blocked. In some cases, a similar biometrics match process may be performed at the payment process instead of the check-in process.

The check-in process signals the transaction support system 20 to open a ticket that identifies a specific merchant and a specific customer device. The ticket may include the DLC. After the customer finishes his meal or decides what to purchase, the merchant system presents the total amount owed to the transaction support server 20, which adds the charge amount to the ticket and sends a request for payment to the customer device 30. Upon reviewing the presented amount, the customer may add a tip and initiate the payment process 90, for example by activating the “Pay” button. If there is any question on the charge amount, the customer may have the option to send a comment to the merchant—for example, “My lemonade never came, could you delete the charge?” or “The basketball is advertised to be 15% off, why is the discount not applied?” After the question is resolved and the final amount is agreed on, the customer expresses his intent to pay the agreed amount, for example by activating the “Pay” button.

In response to the “Pay Now” instruction that starts the payment process 90, the customer device 30 creates a biometric user authentication token and a location token and transmits the two tokens to the transaction support system 20. The transaction support system 20 uses the two tokens to create a Digital Payment Certificate (DPC), which contains the following information:
User name
Venue name
Venue location
Biometric authentication token (AT)
location token (LT)
date and time stamp
intent to pay (e.g., activation of the “Pay” button)
payment information (e.g., amount, tip, card used)
   DPC is used as a security certificate to validate and protect (sign) a digital receipt. Once payment is completed by the user, a digital receipt (DR) signed by DPC is transmitted to the Data Repository, where the combination of Digital Login Certificate, Digital Payment Certificate, and the DR are stored as a Visit Log. Typically, the time stamps on the DLC and DPC indicate different times. A Visit Log contains all authenticated and digitally signed information related to a specific Customer's transaction to the merchant, and protects all parties involved in the transaction should a dispute arise. Optionally, the Digital Receipt may be transmitted to the customer device to confirm that the payment was successfully processed.

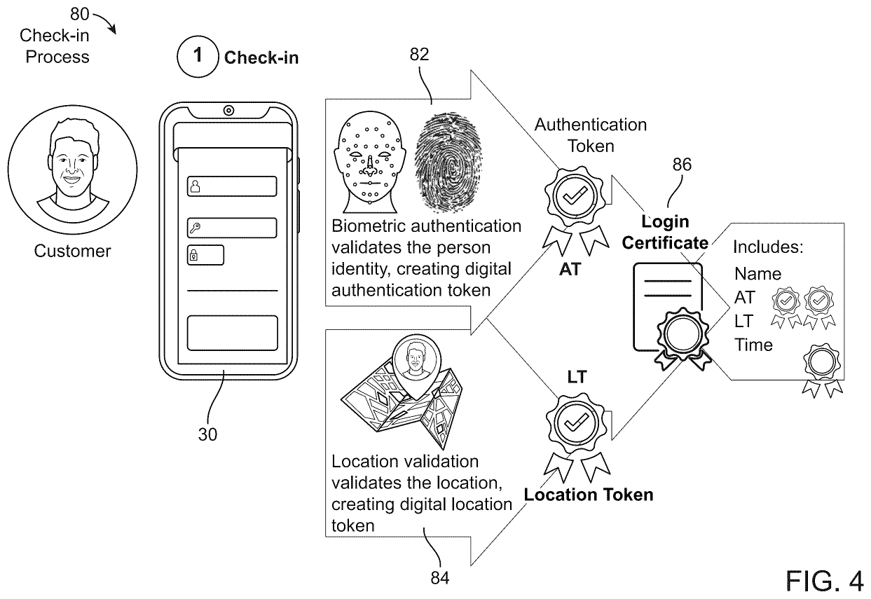

FIG. 4 depicts the Check-in Process 80 in more detail. As shown, a customer uses customer device 30 to check in, for example by activating the “Check in” button on an application on his device 30. In response to the activation of “check in,” the biometric authentication token 82 and location authentication token 84 are taken to create a digital login certificate (DLC) 86. The DLC may be generated by the transaction support server 20 or by the customer device 30.

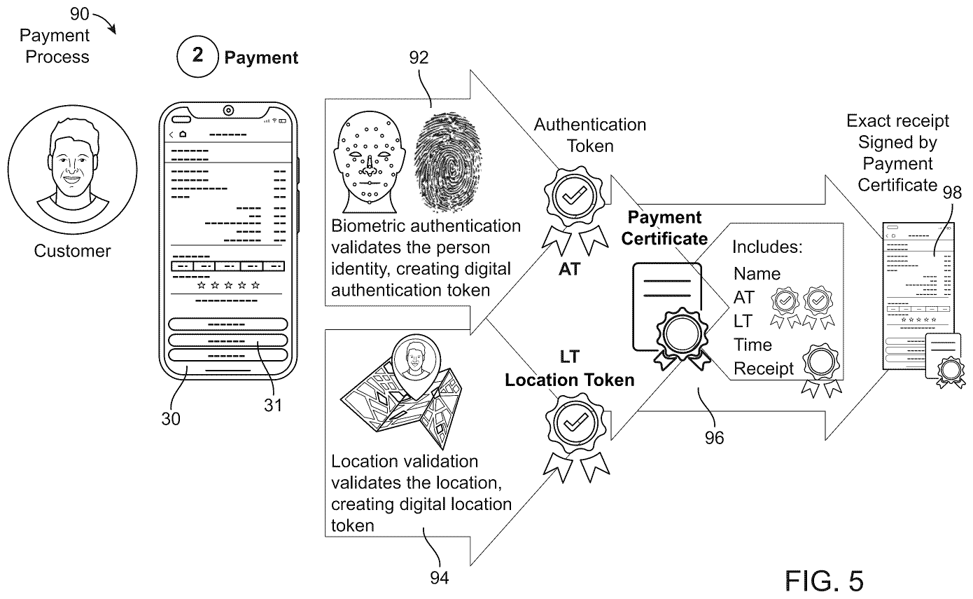

FIG. 5 depicts the payment process 90 in more detail. As shown, the Customer initiates the payment process, for example by activating the “Pay Now” button 31 on his customer device 30. In response to the activation of the “Pay Now” button, biometric authentication token 92 and location authentication token 94 are generated, and used to generate a digital payment certificate (DPC) 96. The DPC 96 is then used to sign a Digital Receipt 98, which makes up part of the Visit Log for the particular transaction.

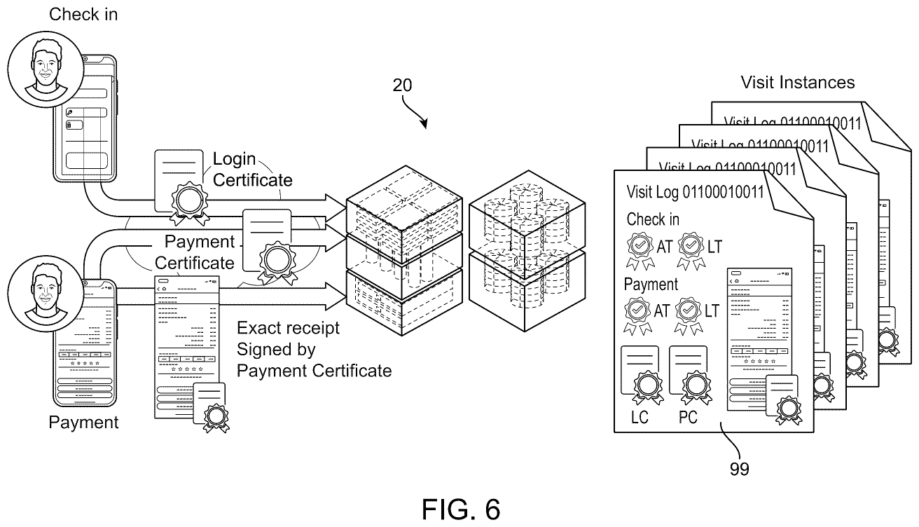

As shown in FIG. 6, a Visit Log 99 is created and updated with every electronic transaction, any one of which may be retrieved if there is a dispute. The visit Log 99 may be stored, for example, in the Repository 40. Each Visit record may contain the DLC 86, DPC 96, and the digital receipt signed by DPC 96.

The dispute resolution processes disclosed herein are intended to happen without any human or manual involvement from the merchant, the Processor, or the customer. The “Processor,” as used herein, refers to an entity acquiring and processing the transaction on behalf of the merchant (e.g., First Data, Retriever). There may be two different kinds of processors-Issuing Processor and Merchant Processor. An Issuing Processor processes on behalf of the bank that issued the credit/debit card; a Merchant Processor processes on behalf of the Merchant or the Acquiring bank. Payment disputes are like insurance against fraud for customers in that they ensure that consumers won't be financially devastated by unauthorized credit card use. Disputes also protect against bad actors who try to scam buyers with defective goods or services. If the credit card issuer is not able to explain the legitimacy of the charge to the customer, the transaction dispute is escalated to a chargeback, which costs the merchant.

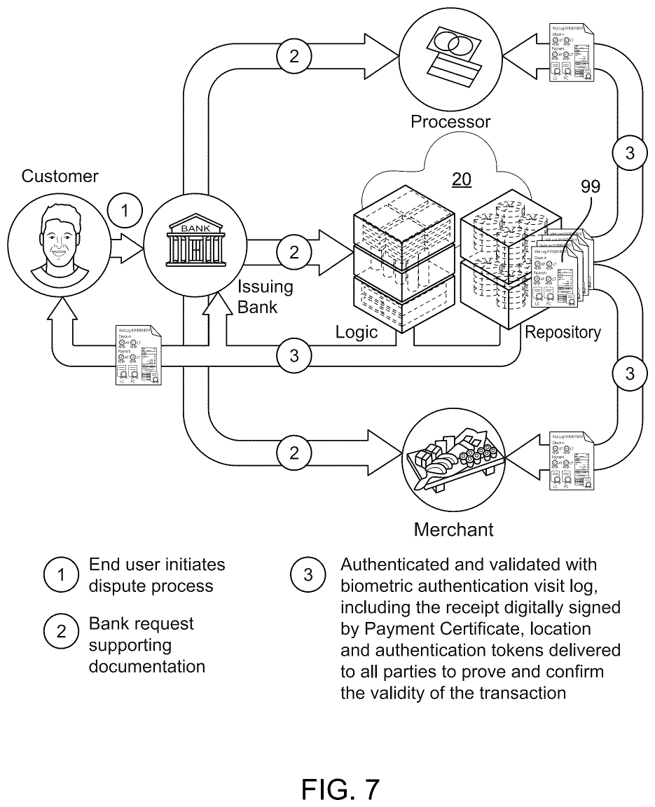

FIG. 7 depicts one embodiment of the dispute resolution process. A payment dispute often starts with a situation in which a customer claims that a transaction registered to his account is invalid. The customer contacts the credit card issuer to explain the situation and ask for a reversal of the charge. In the embodiment of FIG. 4, in response to the customer's initiation of a dispute process with his credit card issuing bank, the issuing bank contacts the transaction support server 20 requesting supporting documentation pertaining to the disputed transaction. In response to the request, the transaction support server 20 automatically retrieves the Visit Log 99 containing all the information related to the disputed transaction, and automatically sends the authenticated and digitally signed information to the parties involved in the dispute. A review of the information should end the dispute.

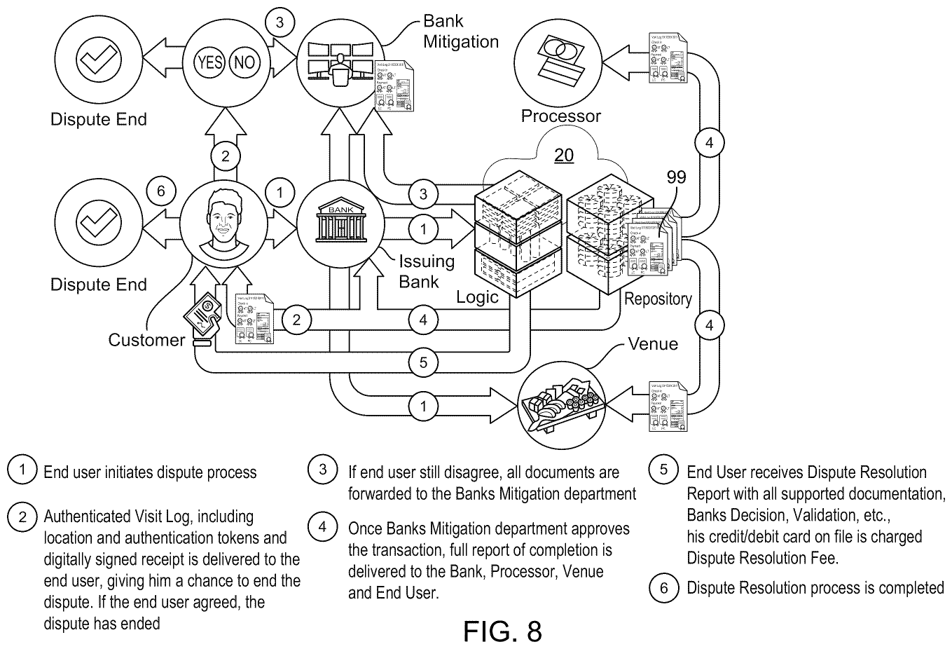

FIG. 8 depicts another embodiment of the dispute resolution process. In FIG. 8, when the customer initiates the dispute process by reaching out to his credit card issuing bank, the issuing bank may send a request for supporting documentation to the transaction support server 20. Alternatively, the credit card issuing bank may contact the merchant's bank, the merchant, or the Processor and one of those contacted entities might send a request for supporting documents to the transaction support server 20. In response to the request, the transaction support server 20 sends the Visit Log 99 with all the information to the customer, demonstrating the validity of the charge. The customer, upon getting his memory refreshed by the Visit Log 99, may acknowledge that legitimacy of the transaction and the acknowledgement is shared with all parties involved in the dispute.

If the customer, after reviewing the Visit Log and all the related information, still does not agree to the legitimacy of the transaction, the customer's denial of the transaction becomes part of the Visit Log 99. The customer's denial may be authenticated too, using any of the suitable known authentication methods. The Visit Log 99 including the denial of transaction may automatically be sent to a Mitigation or Risk department of the issuing bank by the transaction support server 20. Once the information in the Visit Log is reviewed by the issuing bank or the processor, the transaction may be reinstated as valid and the customer may be charged a dispute resolution fee. A vast majority of the time, if not all the time, the transaction will be valid because of the biometric and location authentication that is required during the check-in and payment processes. A fraudulent transaction would have likely been unable to proceed beyond a check-in attempt.

The Dispute Resolution Solutions presented above may be integrated with various POS solutions and Payment Network Processors (e.g., SYS, Shift4, Vanitiv, World Pay, NCR PAY, Chase, Paymentech, GlobalPayments, Heartland, FiServe, First Data, Elavon, EVO, etc.) through Application Programing Interfaces (APIs) and Software Development Toolkits (SDKs).

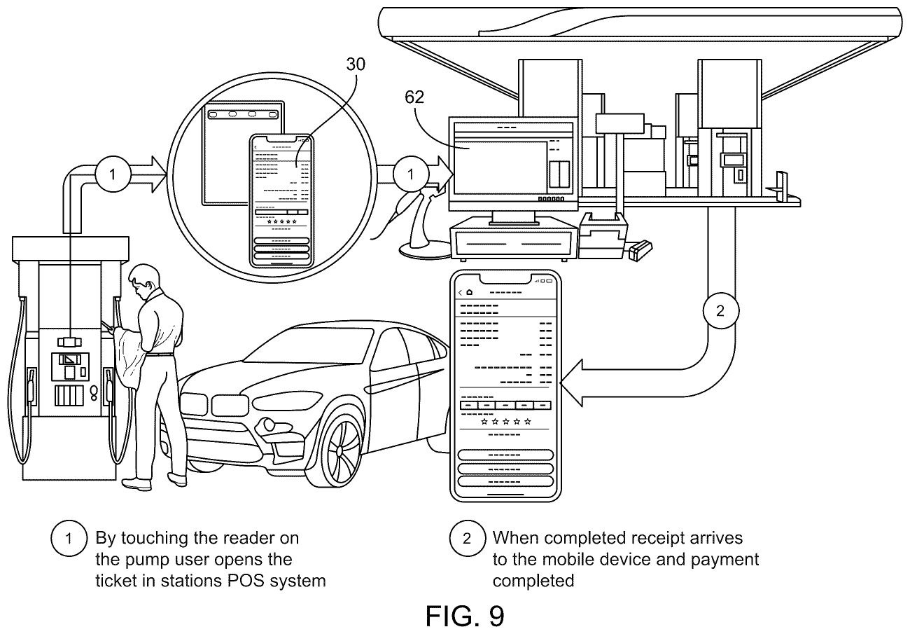

The Dispute Resolution solutions may be used at a fuel station. FIG. 9 depicts how a customer may touch his customer device 30 with the application to a reader connected to the fuel pump to open a ticket in the fuel station's POS 62. The check-in process 80 and payment process 90 may be automatically completed with the customer device 30 and the fuel station's POS 62. After fueling is complete and the charge amount is finalized, payment is automatically processed and digital receipt 98 is generated and stored in the Visit Log 99. A courtesy copy of the digital receipt 98 may also be sent to the customer device 30. By using this application, companies can streamline payment processes at gas stations with additional benefit such as eliminating payment card fraud at the pump, eliminating payment card number theft, all payment using Biometric Authentication and Location Stamp.

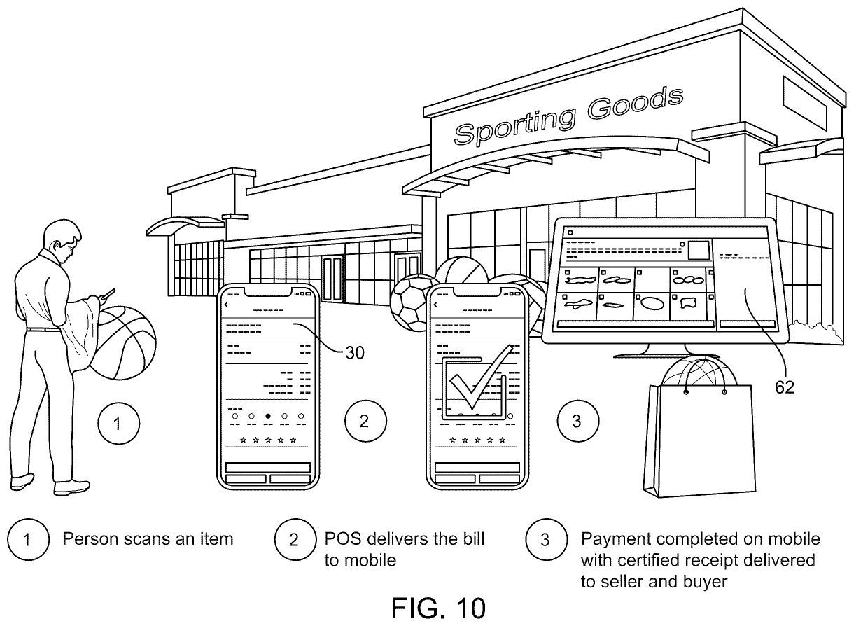

In another example, the transaction system 10 may be integrated with a retail store's POS 62. Unlike in the case of the fuel station above, the customer would not have to physically go to a retail store POS 62 to complete a transaction. FIG. 10 illustrates a customer scanning a retail item with his customer device (OTA POS integration). In response to the scan, the POS delivers the bill to the customer device 30. Customer pays the bill on his customer device 30 by using the payment process 90 described above, and a digital receipt 98 is stored in the Visit Log and optionally, delivered to both the user and the merchant. No sales associates or physical visit to the check-out registers is needed to complete the purchase. Purchases will be protected by the Visit Log 99 described above.

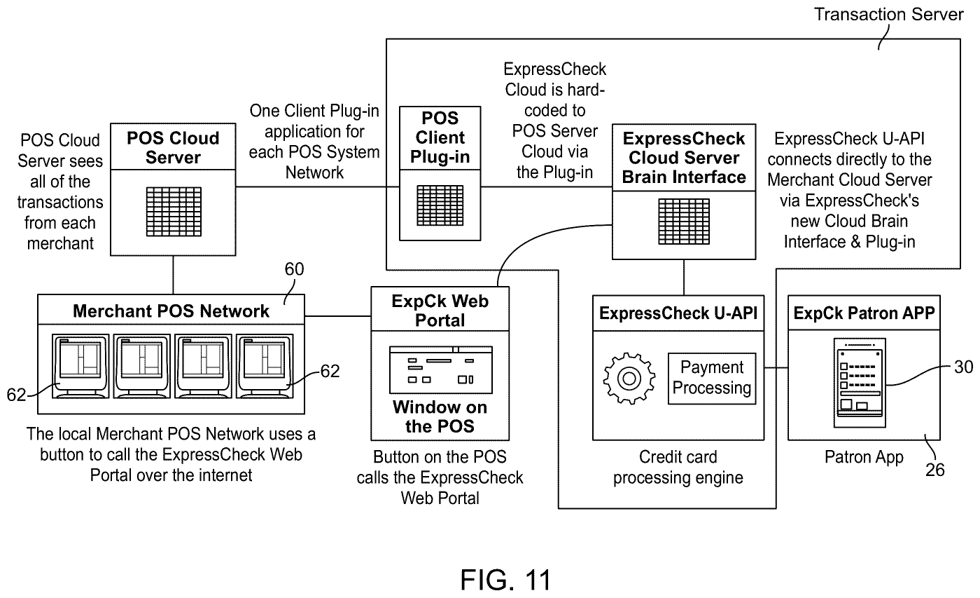

FIG. 11 depicts the method and apparatus in the retail store or restaurant. A merchant may use, for example, a web-based transaction system or a merchant POS system with a plug-in that provides a web interface, such as what is disclosed in U.S. Patent Application Publication No. 2021/0216986 to Jaeb et al. The transaction system depicted in FIG. 11 may be one that allows customers and merchants to conduct electronic transactions without requiring the merchant to purchase and install a separate software program or application for its POS system. For example, the transaction server may include a merchant-specific customer interface program that customers can access with their devices, such as mobile devices. The merchant-specific customer interface program may work together with a plug-in application that connects the merchant POS network 60 to the web so customers can make payments with their devices 30. Using this system, a merchant may record the charge amount into a ticket, which is then presented to the customer device 30. The transaction support system 20 of FIG. 1 may interact with the transaction server of FIG. 11. The customer can then securely pay the charge amount electronically through the transaction support system 20 whenever it is convenient for the customer from any location.

The foregoing description, for purposes of explanation, used specific nomenclature to provide a thorough understanding of the invention. However, it will be apparent to one skilled in the art that the specific details are not required in order to practice the inventive concept. Thus, the foregoing descriptions of specific embodiments of the present invention are presented for purposes of illustration and description. They are not intended to be exhaustive or to limit the invention to the precise forms disclosed. Many modifications and variations are possible in view of the above teaching.

The embodiments were chosen and described to best explain the principles of the inventive concept and its practical applications, to thereby enable others skilled in the art to best utilize the invention and various embodiments with various modifications as are suited to the particular use contemplated. Also, individual features of any of the various embodiments or configurations described above can be mixed and matched in any manner, to create further embodiments contemplated by the disclosure.

What is claimed is:

1. A method of creating an electronic transaction record between a customer and a merchant, comprising:
generating a digital payment certificate comprising the customer's biometric authentication token that is associated with a time of payment instruction from the customer to use a payment method; and
generating a digital receipt signed with the digital payment certificate after executing the payment instruction using the payment method.

2. The method of claim 1, further comprising:
receiving a charge amount from a merchant system;
generating a ticket with the charge amount; and
transmitting the ticket to a customer device that is associated with the customer's biometric authentication token.

3. The method of claim 2, further comprising generating the digital payment certificate in response to receiving the payment instruction from the customer device.

4. The method of claim 3, wherein the digital payment certificate further includes a location token associated with the customer device's location at the time the payment instruction was sent.

5. The method of claim 1, wherein the digital payment certificate further comprises:
a customer name associated with the customer device;
a merchant name;
a merchant location;
a location token associated with a location of the customer's device;
a date and time stamp associated with pay instruction;
an intent to pay; and
payment amount information.

6. The method of claim 1, further comprising generating a digital log-in certificate comprising at least one of a customer's biometric authentication token and a location token at a check-in time.

7. The method of claim 6, wherein the generating of the digital log-in certificate is performed in response to a check-in notification from a customer device.

8. The method of claim 6, wherein the location token identifies a location of the customer device at the check-in time.

9. The method of claim 6, wherein the biometric authentication token comprises one or more of the customer's facial scan, iris scan, fingerprint scan, retina scan, and photograph.

10. The method of claim 6, wherein the digital log-in certificate further comprises a customer name associated with the customer device, a merchant name, a check-in intent, and a date and time associated with the check-in intent.

11. The method of claim 6, further comprising storing the digital log-in certificate and the digital payment certificate as a visit log.

12. The method of claim 11, further comprising maintaining a data repository of visit logs for a plurality of customers and a plurality of merchants.

13. The method of claim 1, further comprising transmitting the digital receipt to the customer device.

14. The method of claim 1, further comprising maintaining a customer database of customer information including biometric data and at least one payment method associated with the biometric data.

15. The method of claim 14, further comprising:
comparing the customer's biometric authentication token against the biometric data in the customer database that is associated with a payment method being used; and
rejecting a payment instruction if the customer's biometric authentication token does not match the biometric authentication token in the customer database.

16. One or more non-transitory computer-readable media collectively storing instructions that, when executed, cause one or more computers to collectively perform a method of creating an electronic record of a transaction between a customer and a merchant, the instructions comprising:
instructions for generating a digital payment certificate comprising the customer's biometric authentication token that is associated with a payment instruction from a customer to use a payment method; and
instructions for generating a digital receipt signed with the digital payment certificate after executing the payment instruction using the payment method.

17. The non-transitory computer-readable media of claim 16, the instructions further comprising instructions to generate a location token for the digital payment certificate, the location token indicating the customer device's location at the time the payment instruction was sent.

18. The non-transitory computer-readable media of claim 16, the instructions further comprising instructions to generate a digital log-in certificate comprising at least one of a customer's biometric authentication token and a location token obtained at a check-in time.

19. The non-transitory computer-readable media of claim 16, the instructions further comprising:
instructions to compare the customer's biometric authentication token against stored biometric data in a customer database that is associated with the payment method being used; and
instructions to reject a payment instruction if the customer's biometric authentication token does not match the stored biometric data.

20. The non-transitory computer-readable media of claim 16, the instructions further comprising storing the digital payment certificate in a visit log.
